(19) United States
(12) Patent Application Publication
(10) Pub. No.: US 2016/0071549 A1
(43) Pub. Date: Mar. 10, 2016

(54) SYNOPSIS VIDEO CREATION BASED ON RELEVANCE SCORE

(71) Applicant: LYVE MINDS, INC., Cupertino, CA (US)

(72) Inventors: Andreas von Sneidern, San Jose, CA (US); Thomas Anderson Keller, Cupertino, CA (US); Mihnea Calin Pacurariu, Los Gatos, CA (US)

(21) Appl. No.: 14/941,293

(22) Filed: Nov. 13, 2015

Related U.S. Application Data
(63) Continuation-in-part of application No. 14/188,431, filed on Feb. 24, 2014.

(51) Int. Cl. G11B 27/30; G11B 27/034; H04N 21/81; H04N 21/8549; H04N 21/4788; H04N 5/77; G11B 31/00

(52) U.S. Cl. CPC G11B 27/30; H04N 5/772; G11B 27/034; G11B 31/006; H04N 21/8549; H04N 21/4788; H04N 21/8133

(57) ABSTRACT

Embodiments described herein include systems and methods for automatically creating compilation videos from a source video based on metadata associated with the source video. For example, a method for creating a compilation video may include receiving a source video having a set of video frames, each video frame in the set of video frames having associated metadata; generating a relevance score for each video frame in the set of video frames based on the associated metadata; selecting a first video frame from the set of video frames based on a first relevance score for the first video frame; and creating the compilation video that includes the first video frame.

### RELATED APPLICATIONS

This application is a continuation-in-part of U.S. patent application Ser. No. 14/188,431, filed Feb. 24, 2014 entitled “AUTOMATIC GENERATION OF COMPILATION VIDEOS,” which is incorporated herein by reference.

### FIELD

This disclosure relates generally to synopsis video creation based on video metadata.

### BACKGROUND

Digital video is becoming as ubiquitous as photographs. The reduction in file size and the increase in quality of video sensors have made video cameras more and more accessible for any number of applications. Mobile phones with video cameras are one example of video cameras being more accessible and usable. Small portable video cameras that are often wearable are another example. The advent of YouTube, Instagram, and other social networks has increased users' ability to share video with others.

### SUMMARY

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

Embodiments described herein include systems and methods for automatically creating compilation videos from a source video based on metadata associated with the source video and/or video frames of the source video. For example, a method for creating a compilation video may include receiving a source video having a set of video frames, each video frame in the set of video frames having associated metadata; generating a relevance score for each video frame in the set of video frames based on the associated metadata; selecting a first video frame from the set of video frames based on a first relevance score for the first video frame; and creating the compilation video that includes the first video frame.

In some embodiments, the method further includes receiving a second source video having a second set of video frames; generating a relevance score for each video frame in the second set of video frames; and selecting a second video frame from the second set of video frames based on a second relevance score for the second video frame. The compilation video may be created to include the second video frame. In some embodiments, the associated metadata includes at least one of: geolocation data, motion data, people tag data, voice tag data, motion tag data, time data, or audio data. In some embodiments, the method further includes receiving a digital audio file that includes a song. The compilation video may be created to have a length that is a same length as the length of the song. In some embodiments, the compilation video has a shorter length than the source video. In some embodiments, the relevance score is a binary value indicative of a location, an orientation, a track volume threshold parameter, a voice tag parameter, a motion, or a person. In some embodiments, the method further includes storing the relevance score for each video frame in a machine-learning database in an aggregate record of relevance scores for each video frame; and creating a second compilation video based on the aggregate record.

Some embodiments may include a non-transitory computer readable storage medium having encoded therein programming code executable by a processor to perform any of the operations described herein. Some embodiments include a mobile device that includes an image sensor, a memory and a processor operatively coupled to the memory. The processor may be configured to perform any of the operations described herein.

### BRIEF DESCRIPTION OF THE FIGURES

These and other features, aspects, and advantages of the present disclosure are better understood when the following Detailed Description is read with reference to the accompanying drawings.

FIG. 1 illustrates an example block diagram of a system that may be used to record source video and/or create compilation videos based on a source video(s) according to some embodiments described.

FIG. 2 illustrates an example data structure according to some embodiments described.

FIG. 3 illustrates an example data structure according to some embodiments described.

FIG. 4 illustrates an example of a packetized video data structure that includes metadata according to some embodiments described.

FIG. 5 illustrates an example flowchart of a process for creating a compilation video according to some embodiments described.

FIG. 6 illustrates an example flowchart of a process for creating a compilation video according to some embodiments described.

FIG. 7 illustrates an example flowchart of a process for creating a compilation video according to some embodiments described.

FIG. 8 illustrates an example flowchart of a process for creating a compilation video using music according to some embodiments described.

FIG. 9 illustrates an example flowchart of a process for creating a compilation video from a source video using music according to some embodiments described.

FIG. 10 illustrates an example flowchart of a process 1000 for creating a compilation video from a source video using supervised learning according to some embodiments.

FIG. 11 illustrates an example flowchart of a process 1100 for creating and validating a machine-learned algorithm according to some embodiments.

FIG. 12 illustrates an example cross validation model to train an algorithm for creating compilation videos in accordance with some embodiments.

FIG. 13 shows an illustrative computer system for performing functionality to facilitate implementation of embodiments described.

### DETAILED DESCRIPTION

Embodiments described include methods and/or systems for creating a compilation video from one or more source videos. Video recording technology has advanced significantly in recent years. Most commercially available mobile devices include a video camera. And, with data storage becoming more inexpensive, mobile devices often come equipped with a large amount of data storage. Taking advantage of the abundance of data storage, many mobile device users are taking significantly more pictures and recording more videos than they would have using film cameras. While the ability to capture more videos can be beneficial to many users, it is not without its drawbacks. In the past, users may have been more circumspect about recording what they anticipated to be the highest quality or most interesting subjects. Now users often may record any and everything with the hopes of editing out the less interesting portions at a later time. This practice may lead to hours of footage to edit, which can be a daunting task for many users. Often, these hours of video are never actually edited leaving viewers with hours of video to sort through to find the most interesting moments.

Aspects of the present disclosure address these and other shortcomings by providing methods and/or systems for automatically creating a compilation video from one or more source videos. The compilation video may be created to be a manageable length that may highlight many of the interesting parts of the one or more source videos while filtering out the less interesting parts. Techniques described herein may be used to identify and learn what makes a video “interesting” and then that knowledge may be used to generate the compilation video.

A compilation video is a video that includes more than one video clip selected from portions of one or more source video(s) and joined together to form a single video. A compilation video may be created based on the metadata associated with the source videos. Compilation videos may further be created based on relevance scores assigned to video frames and/or video clips. A relevance score may indicate, for example, a level of interestingness of the content in a video clip, which may include a level of excitement occurring with the source video as represented by motion data, the location where the source video was recorded, the time or date the source video was recorded, the words used in the source video, the tone of voices within the source video, and/or the faces of individuals within the source video, among others.

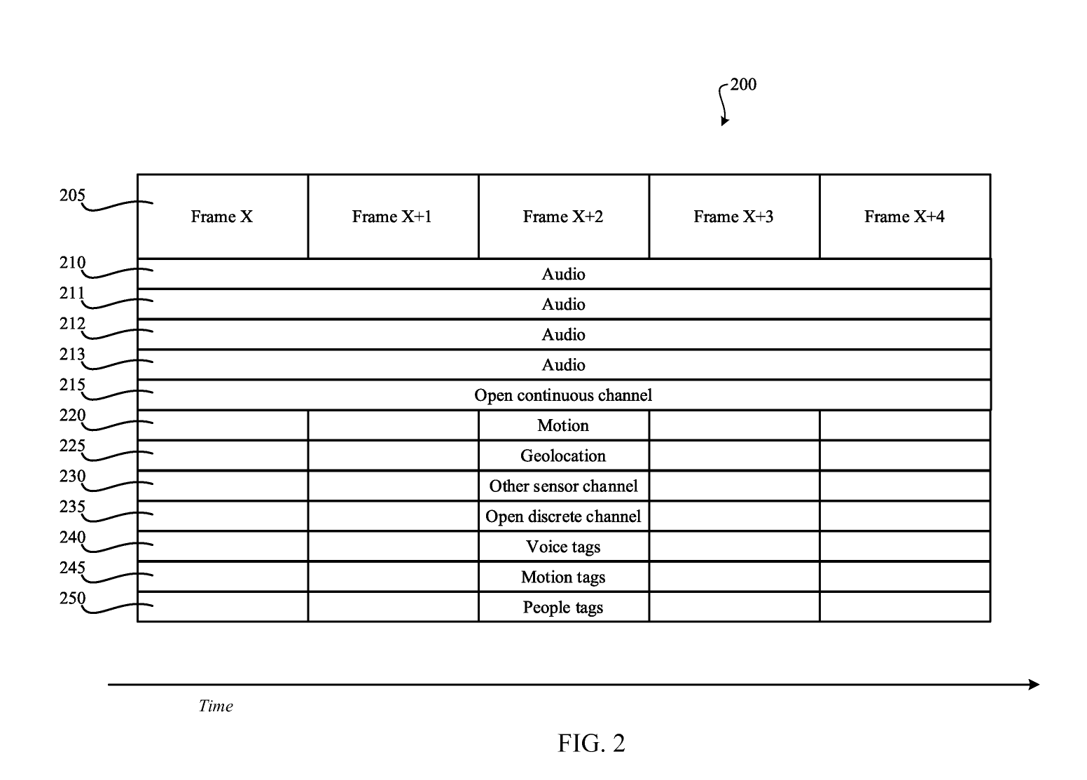

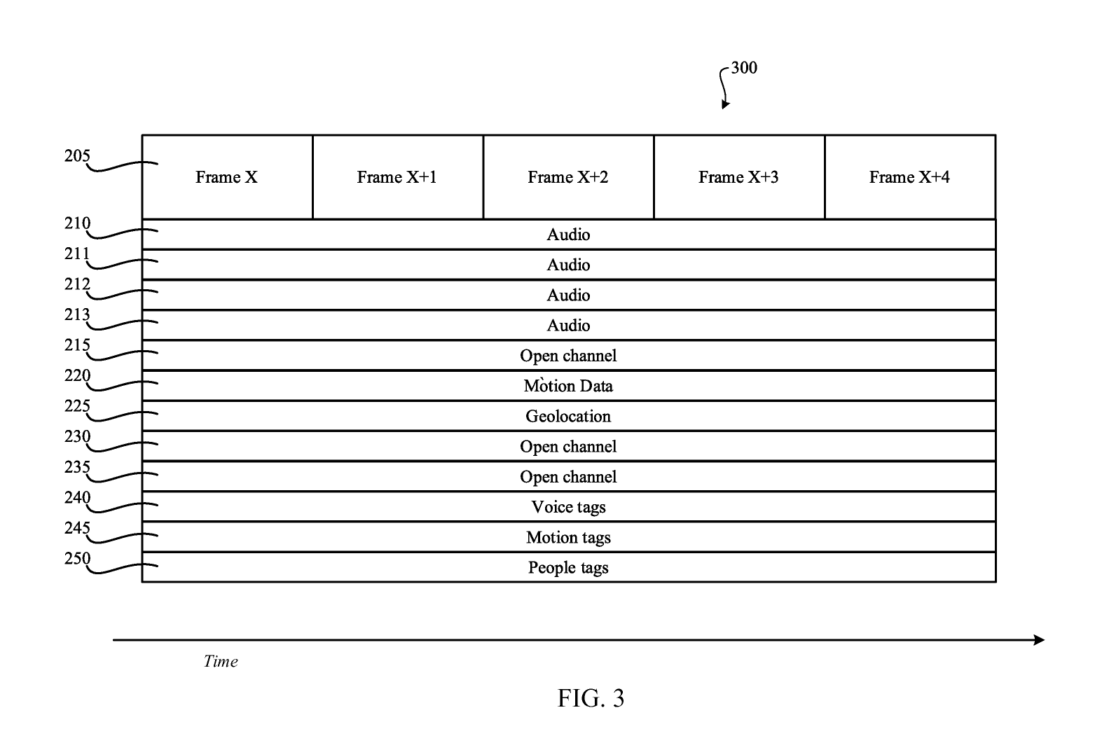

A source video is a video or a collection of videos recorded by a video camera or multiple video cameras. A source video may include one or more video frames (a single video frame may be a photograph) and/or may include metadata such as, for example, the metadata shown in the data structures illustrated in FIG. 2 and FIG. 3. Metadata of a video may include one or more features. These features may include any data that is captured in association with the recording of the video, such as geo location, motion of the video capturing device, etc. Metadata may also include other data such as, for example, a relevance score for each video frame.

A video clip is a collection of one or more continuous or contiguous video frames of a source video. A video clip may include a single video frame and may be considered a photo or an image. A compilation video is a collection of one or more video clips that are combined into a single video.

A baseline feature set may indicate metadata (e.g., features) that may be interesting in conjunction with creating a compilation video. The baseline feature set may identify any number of features and may include a numerical representation for each feature. The numerical representation may indicate a feature's level of interestingness. The baseline feature set may be a set of threshold values for each feature. Source video clips with one or more features that exceed the threshold values of the baseline feature set may be deemed interesting for inclusion in a compilation video. Different baseline feature sets may exist for different types of content. For example, there may exist a baseline feature set for weddings, another baseline feature set for rock concerts, etc. In some embodiments, the baseline feature set may be referred to as an algorithm or as a baseline feature vector. A baseline feature set may be machine learned and may be periodically updated.

In some embodiments, a compilation video may be automatically created from video clips from one or more source videos based on metadata associated with the video clips within the one or more source videos. For instance, the compilation video may be created from video clips with similar metadata. For example, metadata for each video frame of a source video or selected portions of a source video may be identified. The metadata for each video frame may be compiled into a feature vector. The feature vector may be evaluated against a baseline feature set that includes threshold values for the features. Video clips associated with features that exceed one or more of the thresholds in the baseline feature set may be organized into a compilation video based on the metadata.

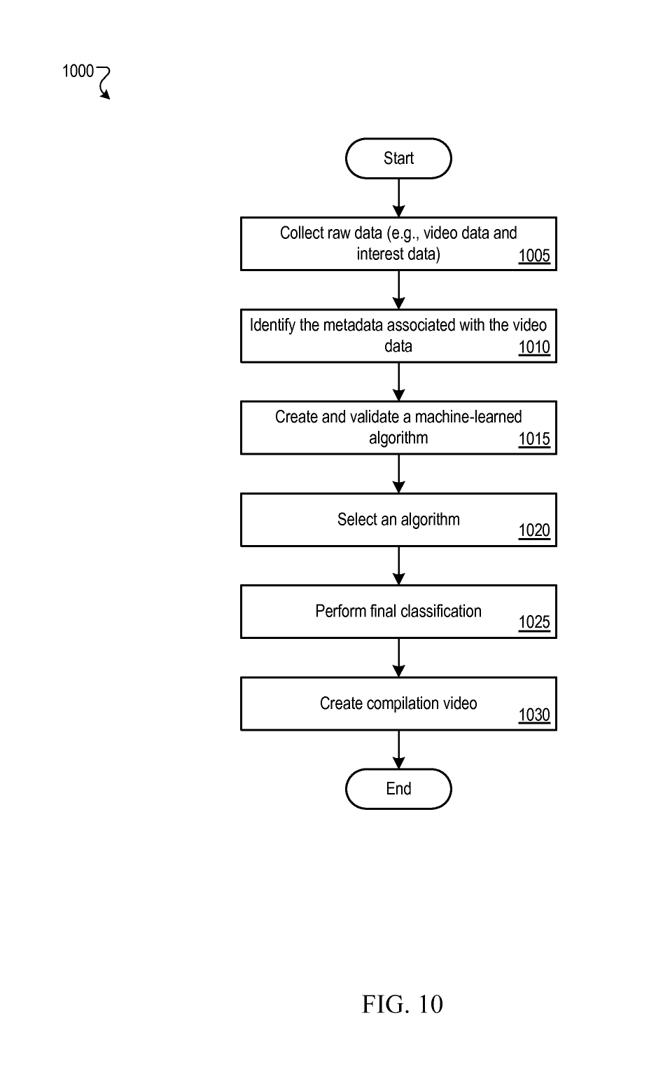

In some embodiments, a compilation video may be automatically created from video clips from one or more source videos based on relevance scores associated with the video clips within the one or more source videos. For instance, the compilation video may be created from video clips with the highest or high relevance scores. For example, each video frame of a source video or selected portions of a source video may be given a relevance score based on any type of data. This data may be metadata collected when the video was recorded or created from the video (or audio) during post processing. In some embodiments, a feature vector may be calculated from the metadata, as further described in conjunction with FIGS. 10-12. The feature vector may be used to generate a relevance score for each video frame. Video frames with high relevance scores may be organized into a compilation video.

In some embodiments, a compilation video may be created for each source video recorded by a camera. These compilation videos, for example, may be used for preview purposes like an image thumbnail and/or the length of each of the compilation videos may be shorter than the length of each of the source videos.

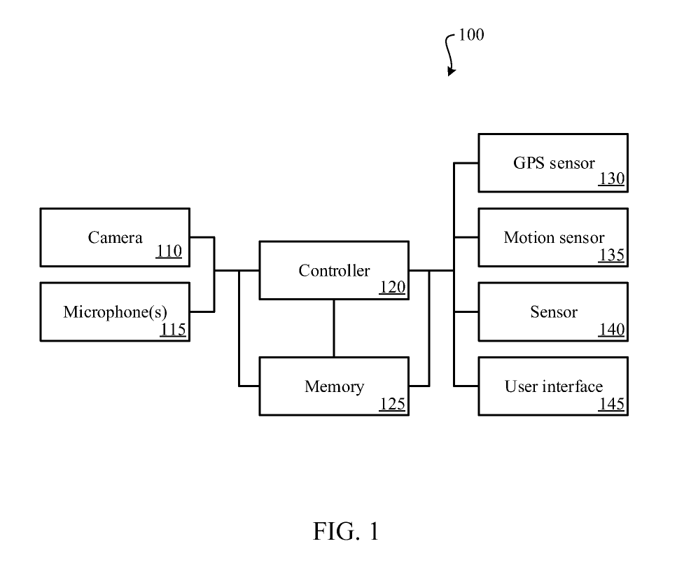

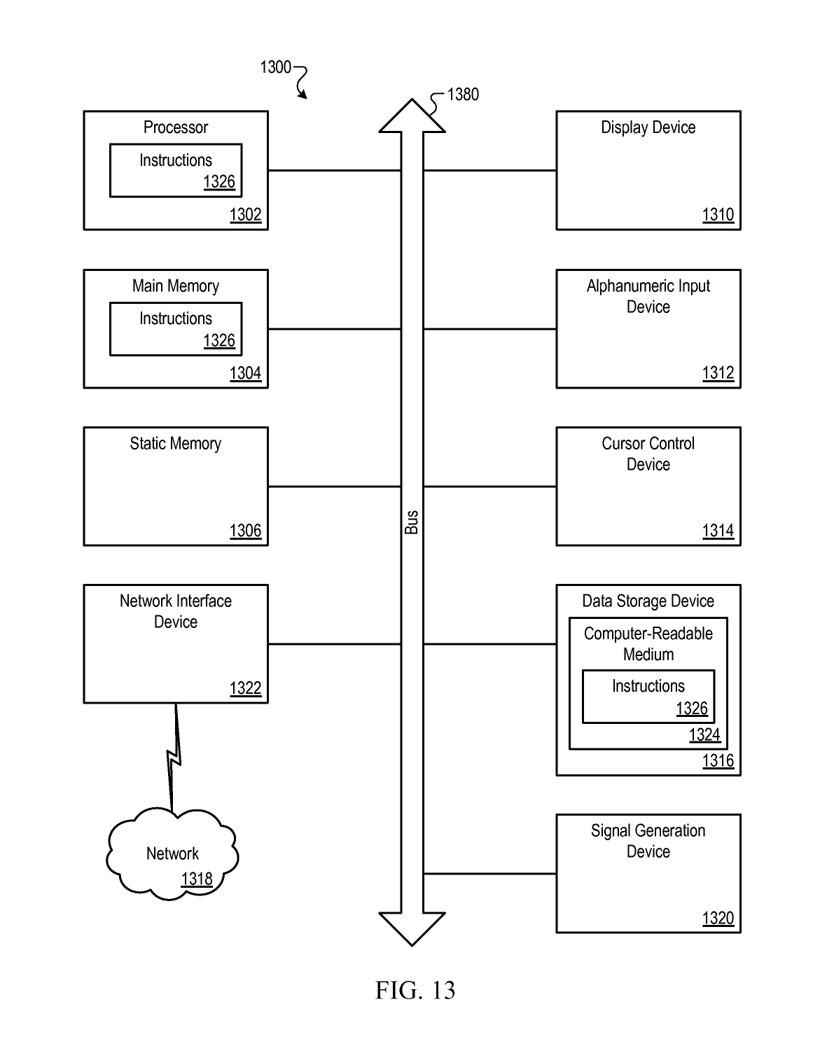

FIG. 1 illustrates an example block diagram of a system 100 that may be used to record source video and/or create compilation videos based on a source video(s) according to some embodiments described. The system 100 may include a camera 110, a microphone 115, a controller 120, a memory 125, a GPS sensor 130, a motion sensor 135, sensor(s) 140, and/or a user interface 145. The controller 120 may include any type of controller, processor, or logic. For example, the controller 120 may include all or any of the components of a computer system 1300 shown in FIG. 13. The system 100 may be a smartphone, camera or tablet.

The camera 110 may include any camera that records digital video of any aspect ratio, size, and/or frame rate. The camera 110 may include an image sensor that samples and records a field of view. The image sensor, for example, may include a CCD or a CMOS sensor. For example, the aspect ratio of the digital video produced by the camera 110 may be 1:1, 4:3, 5:4, 3:2, 16:9, 10:7, 9:5, 9:4, 17:6, etc., or any other aspect ratio. As another example, the size of the camera's image sensor may be 9 megapixels, 15 megapixels, 20 megapixels, 50 megapixels, 100 megapixels, 200 megapixels, 500 megapixels, 1000 megapixels, etc., or any other size. As another example, the frame rate may be 24 frames per second (fps), 25 fps, 30 fps, 48 fps, 50 fps, 72 fps, 120 fps, 300 fps, etc., or any other frame rate. The frame rate may be an interlaced or progressive format. Moreover, the camera 110 may also, for example, record 3-D video. The camera 110 may provide raw or compressed video data. The video data provided by the camera 110 may include a series of video frames linked together in time. Video data may be saved directly or indirectly into the memory 125.

The microphone 115 may include one or more microphones for collecting audio. The audio may be recorded as mono, stereo, surround sound (any number of tracks), Dolby®, etc., or any other audio format. Moreover, the audio may be compressed, encoded, filtered, compressed, etc. The audio data may be saved directly or indirectly into the memory 125. The audio data may also, for example, include any number of tracks. For example, for stereo audio, two tracks may be used. And, for example, surround sound 5.1 audio may include six tracks.

The controller 120 may be communicatively coupled with the camera 110 and the microphone 115 and/or may control the operation of the camera 110 and the microphone 115. The controller 120 may also be used to synchronize the audio data and the video data. The controller 120 may also perform various types of processing, filtering, compression, etc. of video data and/or audio data prior to storing the video data and/or audio data into the memory 125. The controller 120 may automatically create a compilation video from video clips based on metadata associated with the video clips. For example, the controller 120 may assign a relevance score to each video frame of a source video or to selected portions of a source video based metadata associated with each video frame. The metadata have been collected when the video was recorded or created from the video (or audio) data during post processing. In some embodiments, the controller 120 may calculate a feature vector from the metadata. The controller 120 may use the feature vector to create the relevance score for each video frame. The video clips may then be organized into a compilation video based on these relevance scores.

The GPS sensor 130 may be communicatively coupled (either wirelessly or wired) with the controller 120 and/or the memory 125. The GPS sensor 130 may include a sensor that may collect GPS data. In some embodiments, the GPS data may be sampled and saved into the memory 125 at the same rate as the video frames are saved. Any type of the GPS sensor may be used. GPS data may include, for example, the latitude, the longitude, the altitude, a time of the fix with the satellites, a number representing the number of satellites used to determine GPS data, the bearing, and speed. The GPS sensor 130 may record GPS data into the memory 125. For example, the GPS sensor 130 may sample GPS data at the same frame rate as the camera records video frames and the GPS data may be saved into the memory 125 at the same rate. For example, if the video data is recorded at 24 fps, then the GPS sensor 130 may be sampled and stored 24 times a second. Various other sampling times may be used. Moreover, different sensors may sample and/or store data at different sample rates.

The motion sensor 135 may be communicatively coupled (either wirelessly or wired) with the controller 120 and/or the memory 125. The motion sensor 135 may record motion data into the memory 125. The motion data may be sampled and saved into the memory 125 at the same rate as video frames are saved in the memory 125. For example, if the video data is recorded at 24 fps, then the motion sensor may be sampled and stored in data 24 times a second.

The motion sensor 135 may include, for example, an accelerometer, gyroscope, and/or a magnetometer. The motion sensor 135 may include, for example, a nine-axis sensor that outputs raw motion data in three axes for each individual sensor: acceleration, gyroscope, and magnetometer, or it may output a rotation matrix that describes the rotation of the sensor about the three Cartesian axes. Moreover, the motion sensor 135 may also provide acceleration data. The motion sensor 135 may be sampled and the motion data saved into the memory 125.

Alternatively, the motion sensor 135 may include separate sensors such as a separate one-, two-, or three-axis accelerometer, a gyroscope, and/or a magnetometer. The raw or processed data from these sensors may be saved in the memory 125 as motion data.

The sensor(s) 140 may include any number of additional sensors communicatively coupled (either wirelessly or wired) with the controller 120 such as, for example, an ambient light sensor, a thermometer, barometric pressure, heart rate, pulse, etc. The sensor(s) 140 may be communicatively coupled with the controller 120 and/or the memory 125. The sensor(s), for example, may be sampled and the data stored in the memory at the same rate as the video frames are saved or lower rates as practical for the selected sensor data stream. For example, if the video data is recorded at 24 fps, then the sensor(s) may be sampled and stored 24 times a second and GPS may be sampled at 1 fps.

The user interface 145 may be communicatively coupled (either wirelessly or wired) and may include any type of input/output device including buttons and/or a touchscreen. The user interface 145 may be communicatively coupled with the controller 120 and/or the memory 125 via wired or wireless interface. The user interface may provide instructions from the user and/or output data to the user. Various user inputs may be saved in the memory 125. For example, the user may input a title, a location description, an event description, the names of individuals, etc. of a source video being recorded. Data sampled from various other devices or from other inputs may be saved into the memory 125. The user interface 145 may also include a display that may output one or more compilation videos.

FIG. 2 is an example diagram of a data structure 200 for video data that includes video metadata that may be used to create compilation videos according to some embodiments described. The data structure 200 shows how various components may be contained or wrapped within the data structure 200. In FIG. 2, time runs along the horizontal axis and video, audio, and metadata extends along the vertical axis. In this example, five video frames 205 are represented as Frame X, Frame X+1, Frame X+2, Frame X+3, and Frame X+4. These video frames 205 may be a small subset of a much longer video clip. Each video frame 205 may be an image that when taken together with the other video frames 205 and played in a sequence comprises a video clip.

The data structure 200 may also include four audio tracks 210, 211, 212, and 213. Audio from the microphone 115 of FIG. 1 or other source may be saved in the memory 125 as one or more of the audio tracks. While four audio tracks are shown, any number may be used. In some embodiments, each of these audio tracks may comprise a different track for surround sound, for dubbing, etc., or for any other purpose. In some embodiments, an audio track may include audio received from the microphone 115. If more than one of the microphones 115 is used, then a track may be used for each microphone. In some embodiments, an audio track may include audio received from a digital audio file either during post processing or during video capture.

The audio tracks 210, 211, 212, and 213 may be continuous data tracks according to some embodiments described. For example, the video frames 205 are discrete and have fixed positions in time depending on the frame rate of the camera. The audio tracks 210, 211, 212, and 213 may not be discrete and may extend continuously in time as shown. Some audio tracks may have start and stop periods that are not aligned with the video frames 205 but are continuous between these start and stop times.

An open track 215 is a track that may be reserved for specific user applications according to some embodiments described. The open track 215 in particular may be a continuous track. Any number of open tracks may be included within the data structure 200.

A motion track 220 may include motion data sampled from the motion sensor 135 of FIG. 1 according to some embodiments described. The motion track 220 may be a discrete track that includes discrete data values corresponding with each video frame 205. For instance, the motion data may be sampled by the motion sensor 135 at the same rate as the frame rate of the camera and stored in conjunction with the video frames 205 captured while the motion data is being sampled. The motion data, for example, may be processed prior to being saved in the motion track 220. For example, raw acceleration data may be filtered and or converted to other data formats.

The motion track 220, for example, may include nine sub-tracks where each sub-track includes data from a nine-axis accelerometer-gyroscope sensor according to some embodiments described. As another example, the motion track 220 may include a single track that includes a rotational matrix. Various other data formats may be used.

A geolocation track 225 may include location, speed, and/or GPS data sampled from the GPS sensor 130 according to some embodiments described. The geolocation track 225 may be a discrete track that includes discrete data values corresponding with each video frame 205. For instance, the motion data may be sampled by the GPS sensor 130 at the same rate as the frame rate of the camera and stored in conjunction with the video frames 205 captured while the motion data is being sampled.

The geolocation track 225, for example, may include three sub-tracks where each sub-track represents the latitude, longitude, and altitude data received from the GPS sensor 130 of FIG. 1. As another example, the geolocation track 225 may include six sub-tracks where each sub-track includes three-dimensional data for velocity and position. As another example, the geolocation track 225 may include a single track that includes a matrix representing velocity and location. Another sub-track may represent the time of the fix with the satellites and/or a number representing the number of satellites used to determine GPS data. Various other data formats may be used.

Another sensor track 230 may include data sampled from the sensor 140 of FIG. 1 according to some embodiments described. Any number of additional sensor tracks may be used. The other sensor track 230 may be a discrete track that includes discrete data values corresponding with each video frame 205. The other sensor track 230 may include any number of sub-tracks.

An open discrete track 235 is an open track that may be reserved for specific user or third-party applications according to some embodiments described. The open discrete track 235 in particular may be a discrete track. Any number of open discrete tracks 235 may be included within the data structure 200.

A voice tagging track 240 may include voice-initiated tags according to some embodiments described. The voice tagging track 240 may include any number of sub-tracks; for example, a sub-track may include voice tags from different individuals and/or for overlapping voice tags. Voice tagging may occur in real time or during post processing. In some embodiments, voice tagging may identify selected words spoken and recorded through the microphone 115 and save text identifying such words as being spoken during the associated frame. For example, voice tagging may identify the spoken word “Go!” as being associated with the start of action (e.g., the start of a race) that will be recorded in upcoming video frames. As another example, voice tagging may identify the spoken word “Wow!” as identifying an interesting event that is being recorded in the video frame or frames. Any number of words may be tagged in the voice tagging track 240. In some embodiments, voice tagging may transcribe all spoken words into text and the text may be saved in the voice tagging track 240.

A motion tagging track 245 may include data indicating various motion-related data such as, for example, acceleration data, velocity data, speed data, zooming out data, zooming in data, etc. Some motion data may be derived, for example, from data sampled from the motion sensor 135 or the GPS sensor 130 and/or from data in the motion track 220 and/or the geolocation track 225. Certain accelerations or changes in acceleration that occur in a video frame or a series of video frames (e.g., changes in motion data above a specified threshold) may result in the video frame, a plurality of video frames, or a certain time being tagged to indicate the occurrence of certain events of the camera such as, for example, rotations, drops, stops, starts, beginning action, bumps, jerks, etc. Motion tagging may occur in real time or during post processing.

A people tagging track 250 may include data that indicates the names of people within a video frame as well as rectangle information that represents the approximate location of the person (or person's face) within the video frame. The people tagging track 250 may include a plurality of sub-tracks. Each sub-track, for example, may include the name of an individual as a data element and the rectangle information for the individual. In some embodiments, the name of the individual may be placed in one out of a plurality of video frames to conserve data.

The rectangle information, for example, may be represented by four comma-delimited decimal values, such as “0.25, 0.25, 0.25, 0.25.” The first two values may specify the top-left coordinate; the final two specify the height and width of the rectangle. The dimensions of the image for the purposes of defining people rectangles are normalized to 1, which means that in the “0.25, 0.25, 0.25, 0.25” example, the rectangle starts ¼ of the distance from the top and ¼ of the distance from the left of the image. Both the height and width of the rectangle are ¼ of the size of their respective image dimensions.

People tagging may occur in real time as the source video is being recorded or during post processing. People tagging may also occur in conjunction with a social network application that identifies people in images and uses such information to tag people in the video frames and adding people's names and rectangle information to the people tagging track 250. Any tagging algorithm or routine may be used for people tagging.

Data that includes motion tagging, people tagging, and/or voice tagging may be considered processed metadata. Other tagging or data may also be processed metadata. Processed metadata may be created from inputs, for example, from sensors, video, and/or audio.

In some embodiments, discrete tracks (e.g., the motion track 220, the geolocation track 225, the other sensor track 230, the open discrete track 235, the voice tagging track 240, the motion tagging track 245, and/or the people tagging track 250) may span more than one video frame. For example, a single GPS data entry may be made in the geolocation track 225 that spans five video frames in order to lower the amount of data in the data structure 200. The number of video frames spanned by data in a discrete track may vary based on a standard or be set for each video segment and indicated in metadata within, for example, a header.

Various other tracks may be used and/or reserved within the data structure 200. For example, an additional discrete or continuous track may include data specifying user information, hardware data, lighting data, time information, temperature data, barometric pressure, compass data, clock, timing, time stamp, etc.

Although not illustrated, the audio tracks 210, 211, 212, and 213 may also be discrete tracks based on the timing of each video frame. For example, audio data may also be encapsulated on a frame-by-frame basis.

FIG. 3 illustrates a data structure 300, which is somewhat similar to the data structure 200, except that all data tracks are continuous tracks according to some embodiments described. The data structure 300 shows how various components are contained or wrapped within the data structure 300. The data structure 300 includes the same tracks. Each track may include data that is time stamped based on the time the data was sampled or the time the data was saved as metadata. Each track may have different or the same sampling rates. For example, motion data may be saved in the motion track 220 at one sampling rate, while geolocation data may be saved in the geolocation track 225 at a different sampling rate. The various sampling rates may depend on the type of data being sampled, or set based on a selected rate.

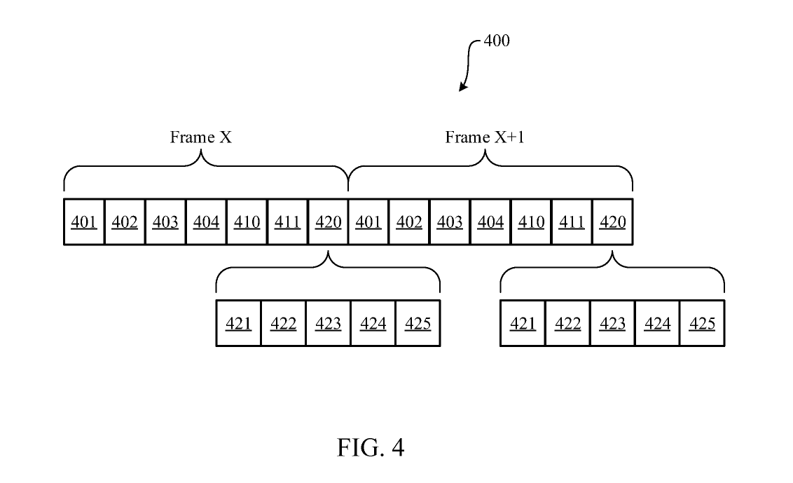

FIG. 4 shows another example of a packetized video data structure 400 that includes metadata according to some embodiments described. The data structure 400 shows how various components are contained or wrapped within the data structure 400. The data structure 400 shows how video, audio, and metadata tracks may be contained within a data structure. The data structure 400, for example, may be an extension and/or include portions of various types of compression formats such as, for example, MPEG-4 part 14 and/or QuickTime formats. The data structure 400 may also be compatible with various other MPEG-4 types and/or other formats.

The data structure 400 includes four video tracks 401, 402, 403, and 404, and two audio tracks 410 and 411. The data structure 400 also includes a metadata track 420, which may include any type of metadata. The metadata track 420 may be flexible in order to hold different types or amounts of metadata within the metadata track. As illustrated, the metadata track 420 may include, for example, a geolocation sub-track 421, a motion sub-track 422, a voice tag sub-track 423, a motion tag sub-track 424, and/or a people tag sub-track 425. Various other sub-tracks may be included.

The metadata track 420 may include a header that specifies the types of sub-tracks contained within the metadata track 420 and/or the amount of data contained within the metadata track 420. Alternatively and/or additionally, the header may be found at the beginning of the data structure or as part of the first metadata track.

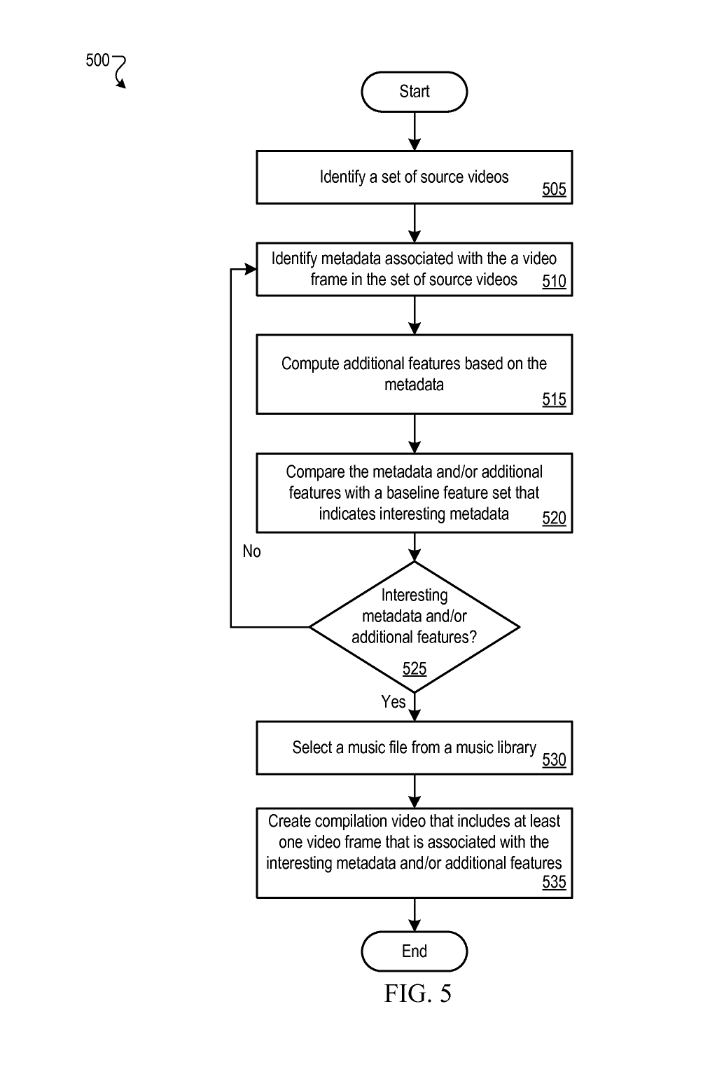

FIGS. 5-11 are flow diagrams of various methods for creating a compilation video from one or more source videos according to some embodiments described. The methods may be performed by processing logic that may include hardware (circuitry, dedicated logic, etc.), software (such as is run on a general purpose computer system or a dedicated machine), or a combination of both, which processing logic may be included in the system 100 or another computer system or device. For simplicity of explanation, methods described are depicted and described as a series of acts. However, acts in accordance with this disclosure may occur in various orders and/or concurrently, and with other acts not presented and described. Further, not all illustrated acts may be required to implement the methods in accordance with the disclosed subject matter. In addition, those skilled in the art will understand and appreciate that the methods could alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used, is intended to encompass a computer program accessible from any computer-readable device or storage media. The methods illustrated and described in conjunction with FIGS. 5-11 may be performed, for example, by a system such as the system 100 of FIG. 1. For clarity of presentation, the description that follows uses the system 100 as an example for describing the methods. However, another system, or combination of systems, may be used to perform the methods.

FIG. 5 illustrates an example flowchart of a process 500 for creating a compilation video from one or more source videos according to some embodiments described. The process 500 may be executed by the controller 120 of FIG. 1 or by any computing device such as, for example, a smartphone and/or a tablet. The process 500 may start at block 505.

At block 505, processing logic may identify a set of source videos. For example, the set of source videos may be identified by a user through a user interface. A plurality of source videos or thumbnails of the source videos may be presented to a user and the user may identify those to be used for the compilation video. In some embodiments, the user may select a folder, or playlist of videos. As another example, the source videos may be organized and presented to a user and/or identified based on metadata associated with the various source videos and/or video frames of the various source videos. For example, the source videos may each be discrete electronic files that include metadata associated with the source videos and/or video frames.

At block 510, the processing logic may identify the metadata associated with the set of source videos. The metadata may include any number of features, for example, the time and/or date each of the source videos were recorded, the geographical region where each of the source videos were recorded, one or more specific words and/or specific faces identified within the source videos, whether video clips within the one or more source videos have been acted upon by a user (e.g., cropped, played, e-mailed, messaged, uploaded to a social network, etc.), the quality of the source videos (e.g., whether one or more video frames of the source videos is over or under exposed, out of focus, videos with red eye issues, lighting issues, etc.), etc. For example, any of the metadata described may be a feature. In some embodiments, the metadata may be stored in a key-based data storage (e.g., a relational database). Each source video and/or video clip may have an associated identifier (e.g., a video ID). Metadata for a source video and/or video clip may be stored in the data storage in association with the video ID. The video ID may be used as a key to retrieve metadata associated with the source video and/or video clip from the data storage.

At block 515, the processing logic may compute additional features based on the metadata (e.g., features) that may relate to the interest level of a source video and/or video clip. The processing logic may use the metadata to calculate the additional features to help characterize the source video and/or video clip. For example, data sampled from the motion sensor 135 or the GPS sensor 130 and/or from data in the motion track 220 and/or the geolocation track 225 may yield nine different outputs that may include three different vectors of accelerations, three gyro readings and three compass headings. From those nine outputs, the processing logic may calculate additional features to imply intelligence to the metadata. The processing logic may organize the metadata (e.g., features) and additional features in a feature vector. For example, from those nine vectors of accelerations (e.g., three gyro readings and three compass headings), the processing logic may calculate different features (e.g., 68 different features) and insert the calculated different features into the feature vector. The additional features may include, for example: a percent of frames manually focused; a ratio of panning-frames to total frames; a ratio of tilting-frames to total frames; an average, median, min, max, and variance of panning speed; an average, median, min, max, and variance of tilting speed; an average, median, min, max, and variance of number of faces; an average and variance of face sizes per frame; an average, median, min, max, and variance of magnitude of user acceleration vector; discrete cosine transform (DCT) components of pitch; DCT components of roll; DCT components of yaw; an average, median, min, max, and variance of speed; DCT components of heading; variance of heading; an average, median, min, max, and variance of distance from horizontal region of interest; DCT components of user acceleration magnitude; an average, median, min, max, and variance of distance from vertical region of interest; a shake value; an average, median, min, max, and variance of GPS displacement; and a percent of frames where a user designation (e.g., a “LyveMoment”) was indicated.

In a specific example, the processing logic may detect tilt by computing a tilt angle from a gravity vector. An example equation for detecting tilt may be represented as:

$${θ}_{tilt} = ( \frac{Gravity \cdot z}{Gravity \cdot {x}^{2} + Gravity \cdot {y}^{2}} ) .$$

The processing logic may apply a lowpass filter to the tilt angle to remove shake data that may have been captured in response to a user device being shaken. A first derivative of the low-passed tilt angle may be computed to yield a tilt speed, where the tilt speed may be represented by: tiltSpeed=θ′ₜᵢₗₜ_{_{—}}_{lowpass}. The processing logic may apply a speed threshold to detect tilting when the tilt speed exceeds the speed threshold.

In another example, the processing logic may determine a shake value by applying a high pass filter to each axis (e.g., x, y, z) of the user device acceleration data by applying a sliding window for the acceleration data on each axis. The sliding windows may be useful when calculating additional features using time-based metadata and to calculate time-based additional features. Each sliding window may have a specified length and offset. For example, a sliding window may have a window length of 5 seconds and may start at a time 1.667 seconds offset from the beginning of the track. The shake value for each sliding window may be the median of the variance of the three high-passed acceleration values for each window.

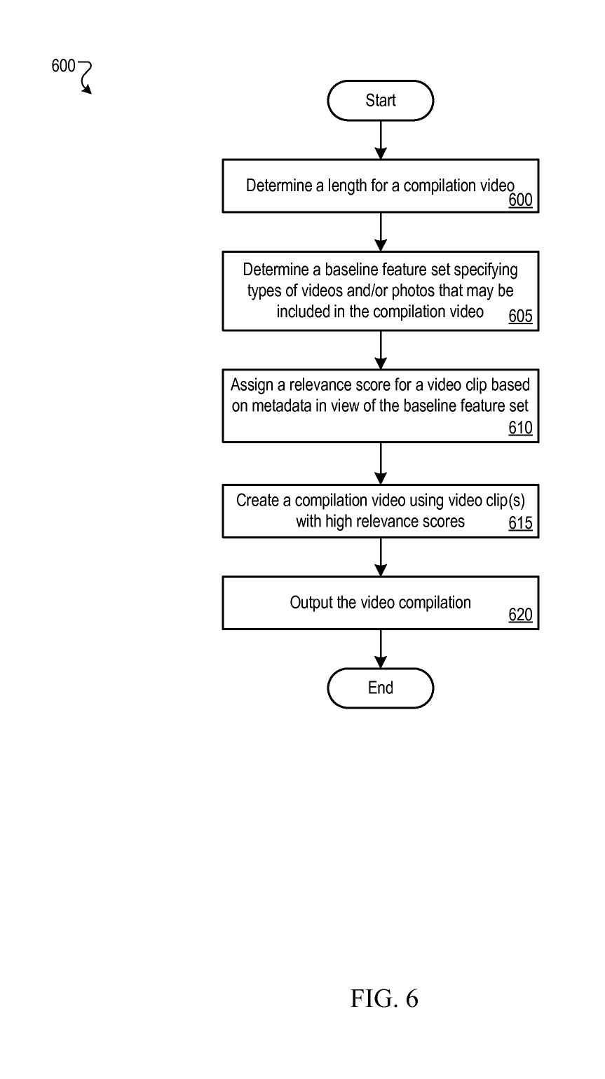

At block 520, the processing logic may compare the metadata and/or additional features of the source video with a baseline feature set that indicates interesting metadata. The baseline feature set may include baseline data pertaining to some or all of the metadata and some or all of the additional features computed at block 515. For example, the baseline feature set may include features that may be useful to predict interestingness for the video frames. Some features may indicate interestingness or lack of interestingness. Camera movements, for example, may be indicative of the interestingness of the subject matter of the video. When a camera is moved at a certain velocity or within a given acceleration range, the video frames captured during that time may be interesting. For example, when a user pans a camera at a slow rate, the user may be taking a panoramic video, which may be interesting. In another example, while recording a video, a user may look at the screen to adjust recording settings and, to do so, the user may tilt the camera down, which records a video of their feet. Such videos associated with a downward tilt and a slow pan may not be interesting enough to include in a compilation video. To detect video clips of a user recording their feet, the processing logic may identify or compute a tilt value associated with one or more video frames. The baseline feature set may include a threshold tilt value, where video frames above that threshold tilt value are deemed not interesting because they are likely a video of a user's feet. Thus, the processing logic may compare a feature vector for each video frame and compare it to the baseline feature set. As another example, any of the features discussed below in conjunction with block 610 of process 600 in FIG. 6 may be used. For example, the baseline feature set may indicate that source videos and/or video frames with a particular time stamp (e.g., date and time range of a rock concert), geolocation (e.g., location in which the rock concert was performed), facial recognition, audio data (e.g., loud applauses, exclamatory words or phrases) may be interesting for inclusion in the compilation video. The processing logic may analyze the metadata against the baseline feature set to identify any video frames that are associated with interesting metadata. Combinations of features may also indicate interestingness. For example, as in the example above, a tilt value that indicates the camera is facing the ground may not be interesting by itself, but when combined with another feature, those video frames may be interesting. When the feature vector indicates that the tilt feature indicates that the camera is facing down, but the camera is being panned at a relatively constant rate, the corresponding video clips may be deemed interesting because the camera may be capturing interesting content that is on the ground as opposed to the camera being tilted down with relatively no motion. In some embodiments, some or all of the features in the baseline feature set may be weighted such that video frames may be deemed interesting in spite of some features indicating non-interestingness. The baseline feature set may be selected by a user, a system administrator, the processing logic (as part of a machine learning algorithm) or any combination thereof. In some embodiments, a machine learning system may iteratively identify features that are common to videos that are selected as being “interesting.” The machine learning system may include those features in the baseline feature set while excluding other features from the baseline feature set. For example, the machine learning system may include the top 10 features in the baseline feature set, which, in some embodiments, may include an average magnitude of user acceleration vector, a ratio of panning frames to total frames, a median magnitude of user acceleration vector, a shake value, a ratio of tilting frames to total frames, a first DCT component of user acceleration, a third DCT component of user acceleration, a maximum value of a tilting speed, a first DCT component of roll, and a maximum distance from vertical region of interest.

At block 525, the processing logic may determine whether at least one video frame of the source video includes a feature value that exceeds an interestingness threshold in the baseline feature set. When at least one video frame of the source video includes a feature value that exceeds a threshold in the baseline feature set, the processing logic may mark that video frame for inclusion in the compilation video. In some embodiments, each video frame is given a numerical identifier, such as a sequential number that starts with the first video frame and increases for each sequential video frame. The processing logic may mark the numerical identifier of video frames to be included in the compilation video. These numerical identifiers may be stored in a data storage and may be organized in an order in which they are to appear in the compilation video. The processing logic may identify any number of video frames of the source video that include a feature value that exceeds a threshold in the baseline feature set to be included in the compilation video. Further, the processing may define sets of contiguous video frames as a video clip to be included in the compilation video. A video clip may be identified by a start time and an end time with respect to the length of the source video. Alternatively, a video clip may be identified by a start time and a clip length. Video clip identifiers may be stored in the data storage, such as by a sequential range of video frame identifiers. When no video frames of the source video include a feature value that exceeds a threshold in the baseline feature set, the processing logic may loop to block 510.

At block 530, the processing logic may select a music file from a music library. For example, the music file may be identified in block 505 from a video (or photo) library on a computer, laptop, tablet, or smartphone and the music file may also be identified from a music library on the computer, laptop, tablet, or smartphone. The music file may be selected based on any number of factors such as, for example, a rating or a score of the music provided by the user; the number of times the music has been played; the number of times the music has been skipped; the date the music was played; whether the music was played on the same day as one or more source videos; the genre of the music; the genre of the music related to the source videos; how recent the music was last played; the length of the music; an indication of a user through the user interface, etc. Various other factors may be used to automatically select the music file.

At block 535, the processing logic may create the compilation video to include video frames and/or clips that include a feature value that exceeds a threshold in the baseline feature set as determined at block 525. The video clips and/or video frames from the source videos may be organized into the compilation video based on the selected music and/or metadata associated with video frames of the source videos. For example, one or more video frames from one or more of the source videos in the set of source videos may be copied and used as at least a portion of the compilation video. The one or more video frames from one or more of the source videos may be selected for inclusion in the compilation video based on metadata associated with each frame. For example, video frames that are associated with interesting metadata, as indicated by the baseline feature set, may be included in the compilation video. In some embodiments, a plurality of video frames may be selected from a source video based on the video frames being associated with similar metadata. For example, a contiguous set of video frames that are each associated with the same or similar metadata may be selected as a video clip to be included in the compilation video. Alternatively or additionally, the length of a video clip (or a number of video frames in the video clip) may be extracted from a source video based on a selected period of time. As another example, a plurality of video clips may be added to the compilation video in an order roughly based on the time order the source videos were recorded, and/or based on the rhythm or beat of the music. As yet another example, a relevance score of each of the source videos or each of the video frames may be used to organize the video frames and/or video clips that make up the compilation video, as further described in conjunction with FIG. 6. As another example, a photo may be added to the compilation video to run for a set period of time or a set number of frames. As yet another example, a series of photos may be added to the compilation video in time progression for a set period of time. As yet another example, a motion effect may be added to the photo such as, for example, Ken Burns effects, panning, and/or zooming. Various other techniques may be used to organize the video clips (and/or photos) into a compilation video. As part of organizing the compilation video, the music file may be used as part of or as all of one or more soundtracks of the compilation video. At block 530, the processing logic may output the compilation video, for example, from a computer device (e.g., a video camera, a mobile device) to a video storage hub, computer, laptop, tablet, phone, server, content sharing platform, etc. The compilation video, for example, may also be uploaded or sent to a social media server. The compilation video, for example, may also be used as a preview presented on the screen of a camera or smartphone through the user interface 145 of FIG. 1 showing what a video or videos include or represent a highlight reel of a video or videos. Various other outputs may also be used.

In some embodiments, the compilation video may be output after some action provided by the user through the user interface 145. For example, the compilation video may be played in response to a user pressing a button on a touch screen indicating that they wish to view the compilation video. Or, as another example, the user may indicate through the user interface 145 that they wish to transfer the compilation video to another device.

In some embodiments, the compilation may be output to the user through the user interface 145 along with a listing or showing (e.g., through thumbnails or descriptors) of the one or more source videos (e.g., the various video clips, video frames, and/or photos) that were used to create the compilation video. The user, through the user interface, may indicate that video clips from one or more source videos should be removed from the compilation video by making a selection through the user interface 145. When one of the video clips is deleted or removed from the compilation video, then another video clip from one or more source videos may automatically be selected based on metadata and used to replace the deleted video clip in the compilation video. In other embodiments, the processing logic may output a second compilation video that omits the deleted or removed video clip.

In some embodiments, video clips may be output at block 520 (or at any other output block described in various other processes) by saving a version of the compilation video to a hard drive, to the memory 125 of FIG. 1 or to a network-based storage location.

FIG. 6 illustrates an example flowchart of the process 600 for creating a compilation video from one or more source videos according to some embodiments described. The process 600 may be executed by the controller 120 of FIG. 1 or by any computing device such as a server. The process 600 may start at block 605.

At block 605, the processing logic determines a length of the compilation video. This may be determined in a number of different ways. For example, a default value representing the length of the compilation video may be stored in memory. As another example, the user may enter a value representing a compilation video length through the user interface 145 and have the compilation video length stored in the memory 125. As yet another example, the length of the compilation video may be determined based on the length of a song selected or entered by a user.

At block 610, the processing logic may determine a baseline feature set specifying the types of video clips (or video frames or photos) within the one or more source videos that may be included in the compilation video. The baseline feature set may indicate which metadata (e.g., features) are interesting. The baseline feature set, for example, may be selected and/or entered by a user via the user interface 145 of FIG. 1. A user may select specific metadata that is interesting such that frames that are associated with the metadata are to be included in the compilation video. For example, a user may select portions of a source video that include the face of a particular person. Thus, the baseline feature set specifies that video clips that include the face of that particular person are to be included in the compilation video. In some embodiments, the baseline feature set may include machine-learned data that indicates metadata that is likely to be selected by a user for inclusion in a compilation video. For example, when a threshold number of features are for video clips that include people riding bicycles and for video clips that were captured a threshold distance away from buildings, the machine-learned data can determine that any video clips that include people riding bicycles away from buildings are likely to be relevant and are to be included in the compilation video.

At block 615, the processing logic may assign a relevance score for a video frame or a plurality of frames of the source video based on the baseline feature set determined in block 610. The relevance score may be used to designate the interestingness of a video clip. The relevance score may be represented as a feature vector or as a mathematical manipulation of the feature vector (e.g., a summation of values in the feature vector). The baseline feature set may instruct the processing logic which features to analyze in the source videos. The processing logic may analyze each video clip of the source video and may assign a relevance score for each video clip based on the baseline feature set. For example, the baseline feature set may indicate that horizontal panning is interesting. The processing logic may analyze the source video for horizontal panning. The processing logic may analyze the source videos for one or more interesting features defined by the baseline feature set. The processing logic may use the results of the analysis to generate a relevance score, such as on a per video frame basis. Any number and/or type of features may be used for the relevance score.

In some embodiments, the baseline feature set may include time or date-based features. For example, at block 610 a date or a date range within which video clips were recorded may be identified as a feature. Video frames and video clips of the one or more source videos may be given a relevance score at block 615 based on the time it was recorded. The relevance score, for example, may be a binary value indicating that the video clips within the one or more source videos were taken within a time period provided by the time period feature.

In some embodiments, the geolocation where the video clip was recorded may be a feature identified at block 610 and used in block 615 to give a relevance score to one or more video clips of the source videos. For example, a geolocation feature may be determined based on the average geolocation of a plurality of video clips and/or based on a geolocation value entered by a user. The video clips within one or more source videos taken within a specified geographical region may be given a higher relevance score. As another example, if the user is recording source videos while on vacation, those source videos recorded within the geographical region around and/or near the vacation location may be given a higher relevance score. The geographical location, for example, may be determined based on geolocation data of a source video in the geolocation track 225. As yet another example, video clips within the source videos may be selected based on geographical location and a time period.

As another example, video frames within the one or more source videos may be given a relevance score based on the similarity between geolocation metadata and a geolocation feature provided at block 610. The relevance score may be, for example, a binary value indicating that the video clips within the one or more source videos were taken within a specified geolocation provided by the geolocation feature.

In some embodiments, motion may be a feature identified at block 610 and used in block 615 to score video clips of the one or more source videos. A motion feature may indicate motion indicative of high excitement occurring within a video clip. For example, a relevance score may be a value that is proportional to the amount of motion associated with the video clip. The motion may include motion metadata that may include any type of motion data. In some embodiments, video clips within the one or more source videos that are associated with higher motion metadata may be given a higher relevance score; and video clips within the one or more source videos that are associated with lower motion metadata may be given a lower relevance score. In some embodiments, a motion feature may indicate a specific type of motion above or below a threshold value.

In some embodiments, voice tags, people tags, and/or motion tags may be a feature identified at block 610 and used in block 615 to score the video clips within the one or more source videos. The video clips within the one or more source videos may also be determined based on any type of metadata such as, for example, based on voice tag data within the voice tagging track 240, motion data within the motion tagging track 245, and/or people tag data based on the people tagging track 250. In some embodiments, the relevance score may be a binary value indicating that the video clips within the one or more source videos are associated with a specific voice tag feature, a specific motion, and/or include a specific person. In some embodiments, the relevance score may be related to the relative similarity of voice tags associated with the video clips within the one or more source videos with a voice tag feature. For instance, voice tags that are the same as the voice tag feature may be given one relevance score, and voice tags that are synonymous with the voice tag feature may be given another, lower relevance score. Similar relevance scores may be determined for motion tags and/or people tags.

In some embodiments, a voice tag feature may be used that associates a video clip within the one or more source videos with exclamatory words such as “sweet,” “awesome,” “cool,” “wow,” “holy cow,” “no way,” etc. Any number of words may be used as a feature for a relevance score. The voice tag feature may indicate that the video clips within the one or more source videos may be selected based on words recorded in an audio track of the source video. New or additional words may be entered by the user through the user interface 145. Moreover, new or additional words may be communicated to the processing logic (or another system) wirelessly through Wi-Fi or Bluetooth.

In some embodiments, a voice tone feature may also be used that indicates voice tone within one or more of the audio tracks. The voice tone feature may indicate that video clips within the one or more source videos may be selected based on how excited the tone of voice is in an audio track of the source video versus the words used. As another example, both the tone and the word may be used.

In some embodiments, a people tag feature may be indicated in block 610 and used in block 615 to score the video clips within the one or more source videos. The people tag feature may identify video clips within the one or more source videos with specific people in the video clips.

In some embodiments, video frame quality may be a feature determined in block 610 and used in 615 for a relevance score. For example, video clips within the one or more source videos that are under exposed, over exposed, out of focus, have lighting issues, and/or have red eye issues may be given a lower score at block 615.

In some embodiments, a user action performed on video clips within the one or more source videos may be a feature identified at block 610. For example, video clips within the one or more source videos that have been acted upon by a user such as, for example, video clips within the one or more source videos that have been edited, corrected, cropped, improved, viewed or viewed multiple times, uploaded to a social network, e-mailed, messaged, etc., may be given a higher score at block 615 than other video clips. Moreover, various user actions may result in different relevance scores.

In some embodiments, data from a social network may be used as a feature at block 610. For example, the relevance score determined at block 615 for the video clips within the one or more source videos may depend on the number of views, “likes,” and/or comments related to the video clips. As another example, the video clips may have an increased relevance score if they have been uploaded or shared on a social network.

In some embodiments, the baseline feature set may be determined using off-line processing and/or machine learning algorithms. Machine learning algorithms, for example, may learn which feature within the data structure 200 or 300 are the most relevant to a user or group of users while viewing videos. This may occur, for example, by noting the number of times a video clip is watched, for how long a video clip is viewed, or whether a video clip has been shared with others. These learned features may be used to create a baseline feature set of the relevance scores. The baseline feature set may be used to determine the relevance of the metadata associated with the video clips within the one or more source videos. In some embodiments, these learned features may be determined using another processing system or a server, and may be communicated to the camera 110 through a Wi-Fi or other connection. In some embodiment, the processing logic may create multiple compilation videos using the same source video(s) in response to updates to the baseline feature set.

In some embodiments, more than one feature may be used to score the video frames within the one or more source videos. For example, the compilation video may be made based on people recorded within a certain geolocation and recorded within a certain time period.

At block 620, the processing logic may create a compilation video from the video clips having the metadata with the highest relevance scores. The compilation video may be created by digitally splicing copies of the video clips together. Various transitions may be used between one video clip and another. In some embodiments, video clips may be arranged in order based on the highest scores assigned by the processing logic in block 615. In other embodiments, the video clips may be placed within the compilation video in a random order. In other embodiments, the video clips may be placed within the compilation video in a time series order.

In some embodiments, metadata may be added as text to portions of the compilation video. For example, text may be added to any number of frames of the compilation video stating the people in the video clips based on information in the people tagging track 250, geolocation information based on information in the geolocation track 225, etc. In some embodiments, the text may be added at the beginning or the end. Various other metadata may also be presented as text.

In some embodiments, each video clip may be expanded to include head and/or tail video frames based on a specified head video clip length and/or a tail video clip length. The head video clip length and/or the tail video clip length may indicate, for example, the number of video frames before and/or after a selected video frame or frames that may be included as part of a video clip. For example, if the head and tail video clip length is 96 video frames (4 seconds for a video recorded with 24 frames per second), and if the features indicate that video frames 1004 through 1287 have a high relevance score, then the video clip may include video frames 908 through frames 1383. In this way, for example, the compilation video may include some video frames before and after the desired action. The head and tail video clip length may also be indicated as a value in seconds. Moreover, in some embodiments, a separate head video clip length and a separate tail video clip length may be used. The head and/or tail video clip length may be entered into the memory 125 via the user interface 145. Moreover, a default head and/or tail video clip length may be stored in memory.

Alternatively or additionally, a single head video clip length and/or a single tail video clip length may be used. For example, if the features indicate that a single video frame 1010 has a high relevance score, then a longer head and/or tail may be needed to create a video clip. If both the single head video clip length and the single tail video clip length are 60 frames, then frames 960 through 1060 may be used as the video clip. Any value may be used for the single tail video clip length and/or the single head video clip length.

Alternatively or additionally, a minimum video clip length may be used. For example, if the features indicate a source video clip that is less than the minimum video clip length, then additional video frames may be added before or after the source video clip to achieve the minimum video clip length. In some cases, the source video clip may be centered within the video clip. For example, if the features indicate that video frames 1020 through 1080 have a high relevance score, and a minimum video clip length of 100 video frames is required, then video frames 1000 through 1100 may be used to create the video clip from the source video.

In some embodiments, each video clip being used to create the compilation video may also be lengthened to ensure that the video clip has a length above a selected and/or predetermined minimum video clip length. In some embodiments, photos may be entered into the compilation video for the minimum video clip length or another value.

In some embodiments, the processing logic may select all video clips having a relevance score above a threshold value. The processing logic may add the length of each of the selected video clips to determine a total length for the compilation video. Once the total length for the compilation video is determined, the processing logic may identify a song that has a length that closely matches the total length for the compilation video. In such embodiments, the processing logic may determine the length for the compilation video (block 605) after it performs block 615.

At block 625, the processing logic may output the compilation video, as described above in conjunction with block 520 of the process 500 shown in FIG. 5.

In some embodiments, at least a subset of the video clips used to create the compilation video may be discontinuous relative one to another in a single source video. For example, a first video clip and a second video clip may not have the same video frames. As another example, the first video clip and the second video clip may be located in different portions of the source video.

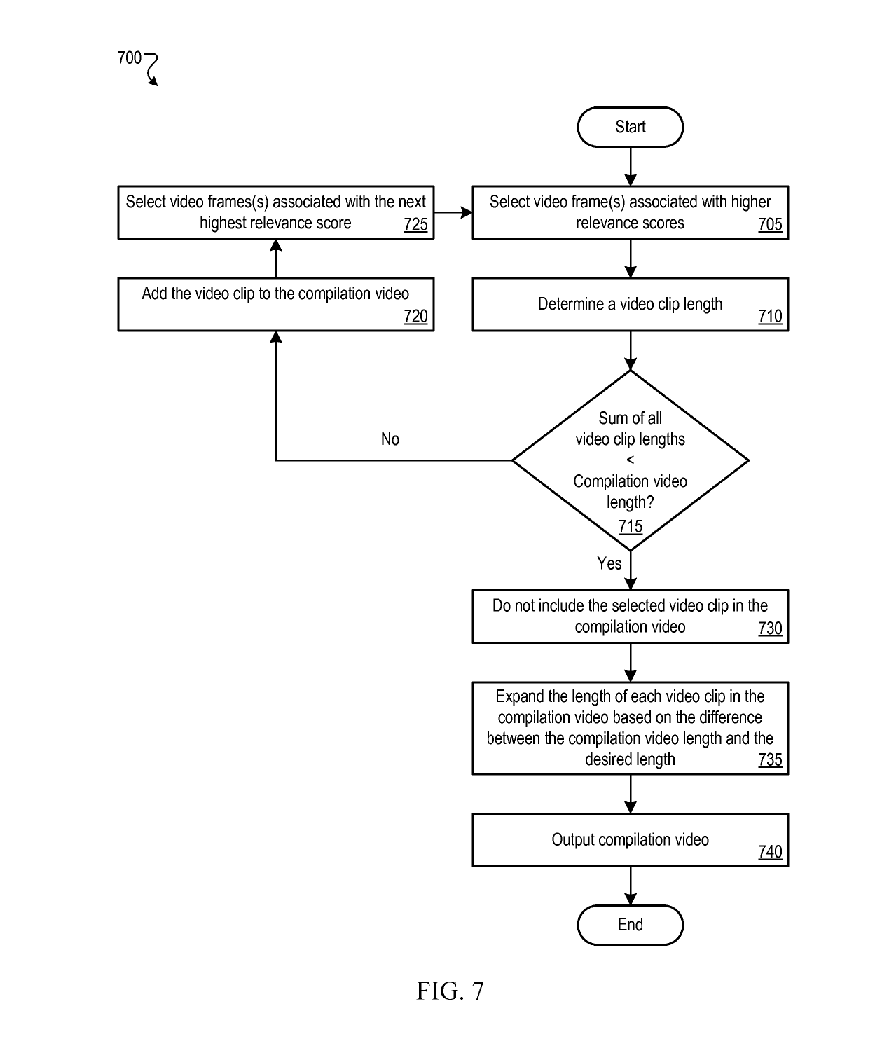

FIG. 7 illustrates an example flowchart of a process 700 for creating a compilation video from one or more source videos according to some embodiments described. The process 700 may be executed by the controller 120 of FIG. 1 or by any computing device. In some embodiments, block 620 of the process 600 shown in FIG. 6 may include all or many of the blocks of the process 700. The various blocks may be performed in any order. The process 700 starts at block 705.

At block 705, processing logic may select the video clip(s) associated with the highest relevance score. The selected clip(s) may include a single frame or a series of frames. If multiple frames have the same relevance score and are not linked together in time series (e.g., the multiple frames do not include a continuous or mostly continuous video clip), then one of these highest scoring frames are selected either randomly or based on being first in time.

At block 710, the processing logic may determine a length of a video clip. For example, the length of the video clip may be determined based on the number of video frames in time series that are selected as a group or have similar relevance scores or have relevance scores within a threshold. It may also include, for example, video frames that are part of head video frames or tail video frames. The length of the video clip may be based at least in part on metadata. The length of the video clip may be determined by referencing a default video clip length stored in memory.

At block 715, the processing logic may determine whether the sum of all the video clip lengths is greater than the compilation video length. For example, at block 715, it may be determined whether there is room in the compilation video for the selected video clip. If there is room, then the video clip is added to the compilation video at block 720. For example, the video clip may be added at the beginning, the end, or somewhere in between other video clips of the compilation video. At block 725, video frames with the next highest scores are selected and the process 700 proceeds to block 710 with the newly selected video clips.

If, however, at block 715, the processing logic determines that there is no room for the video clip in the compilation video, then the processing logic proceeds to block 730 where the video clip is not entered into the compilation video. At block 735, the processing logic may expand the length of one or more video clips in the compilation video to ensure the length of the compilation video is the same as the desired length of the compilation video. For example, if the difference between the length of the compilation video and the desired length of the compilation video is five seconds, which equals 120 frames at 24 frames per second, and if the compilation video comprises ten video clips, then each of the ten video clips may be expanded by 12 frames. The six proceeding frames from the source video may be added to the front of each video clip in the compilation video and the six following frames from the source video may be added to the end of each video clip in the compilation video. Alternatively or additionally, frames may only be added to the front or the back end of a video clip. In some embodiments, to increase the length of a video clip, the processing logic may duplicate a frame and include in the video clip as many frames are needed to achieve the desired length.

In some embodiments, block 735 may be skipped and the compilation video length may not equal the desired compilation video length. In other embodiments, rather than expanding the length of various video clips, the process 700 may search for a highly scored video clip within the source video(s) having a length that is less than or equal to the difference between the compilation video length and the desired compilation video length. In other embodiments, the selected video clip may be shortened in order to fit within the compilation video.

At block 740, the processing logic may output the compilation video as described above in conjunction with block 520 of the process 500 shown in FIG. 5.

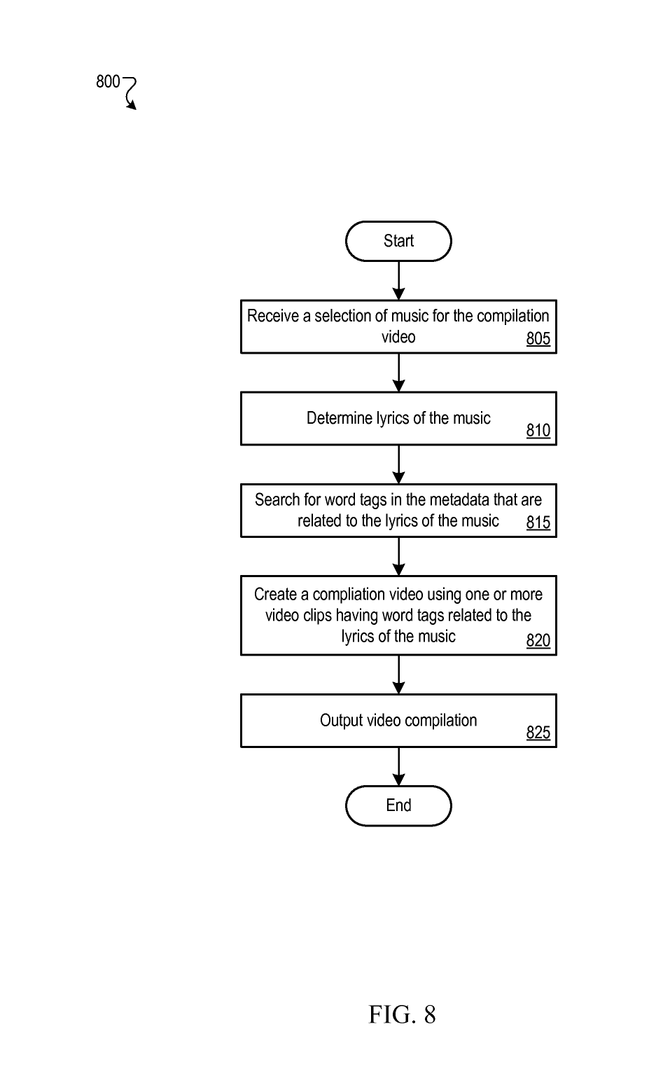

FIG. 8 illustrates an example flowchart of a process 800 for creating a compilation video from a source video using music according to some embodiments described. The process 800 may be executed by the controller 120 of FIG. 1 or by any other computing device. The process 800 may start at block 805.

At block 805, processing logic may receive a selection of music for the compilation video. The selection of the music may be received, for example, from a user through the user interface 145. The selection of music may include a digital audio file of the music indicated by the selection of music. The digital audio file may be uploaded or transferred via any wireless or wired method, for example, using a Wi-Fi transceiver.

At block 810, the processing logic may determine and/or receive lyrics for the selection of music. For example, the lyrics may be received from a lyric database over a computer network. The lyrics may also be determined using voice recognition software. In some embodiments, all the lyrics of the music may be received. In other embodiments only a portion of the lyrics of the music may be received. And, in yet other embodiments, instead of lyrics being received, keywords associated with the music may be determined and/or received.

At block 815, the processing logic may search for word tags in the metadata that are related to lyrics of the music. The word tags, for example, may be found as metadata in the voice tagging track 240. Alternatively and/or additionally, one or more audio tracks may be voice-transcribed and the voice transcription may be searched for words associated with one or more words in the lyrics or keywords associated with the lyrics. Alternatively and/or additionally, keywords related to the song or words within the title of the music lyrics may be used to find word tags in the metadata.

At block 820, the processing logic may create a compilation video using one or more video clips having word tags related to the lyrics of the music. All or portions of the process 600 may be used to create the compilation video. Various other techniques may be used. At block 825, the processing logic may output the compilation video as described above in conjunction with block 520 of the process 500.

In some embodiments, the source videos discussed in processes 500, 600, 700, and/or 800 may include video clips, full length videos, video frames, thumbnails, images, photos, drawings, etc.

In processes 500, 600, 700, and/or 800 source videos, images, photos, and/or music may be selected using a number of features. For example, a photo (image or video frame) may be selected based on the interestingness (or relevance or relevance score) of the photo. A number of factors may be used to determine the interestingness of the photo such as, for example, user interaction with the photo (e.g., the user cropped, rotated, filtered, performed red-eye reduction, etc. on the photo), user ratings of the photo (e.g., IPTC rating, star rating, or thumbs up/down rating), face detection, face recognition, photo quality, focus, exposure, saturation, etc.

As another example, a video (or video clip) may be selected based on the interestingness (or relevance or relevance score) of the video. A number of factors may be used to determine the interestingness of the video such as, for example, telemetry changes in the video (e.g., accelerations, jumps, crashes, rotations, etc.), user tagging (e.g., the user may press a button on the video recorder to tag a video frame or a set of frames as interesting), motion detection, face recognition, user ratings of the video (e.g., IPTC rating, star rating, or thumbs up/down rating), etc.

As another example, a music track may be selected based on the interestingness (or relevance or relevance score) of the music track. A number of factors may be used to determine the interestingness of the music track such as, for example, whether the music is stored locally or whether it may be streamed from a server, the duration of the music track, the number of times the music has been played, whether the music track has been selected previously, user rating, skip count, the number of times the music track has been played since it has been released, how recently the music has been played, whether the music was played at or near recording the source video, etc.

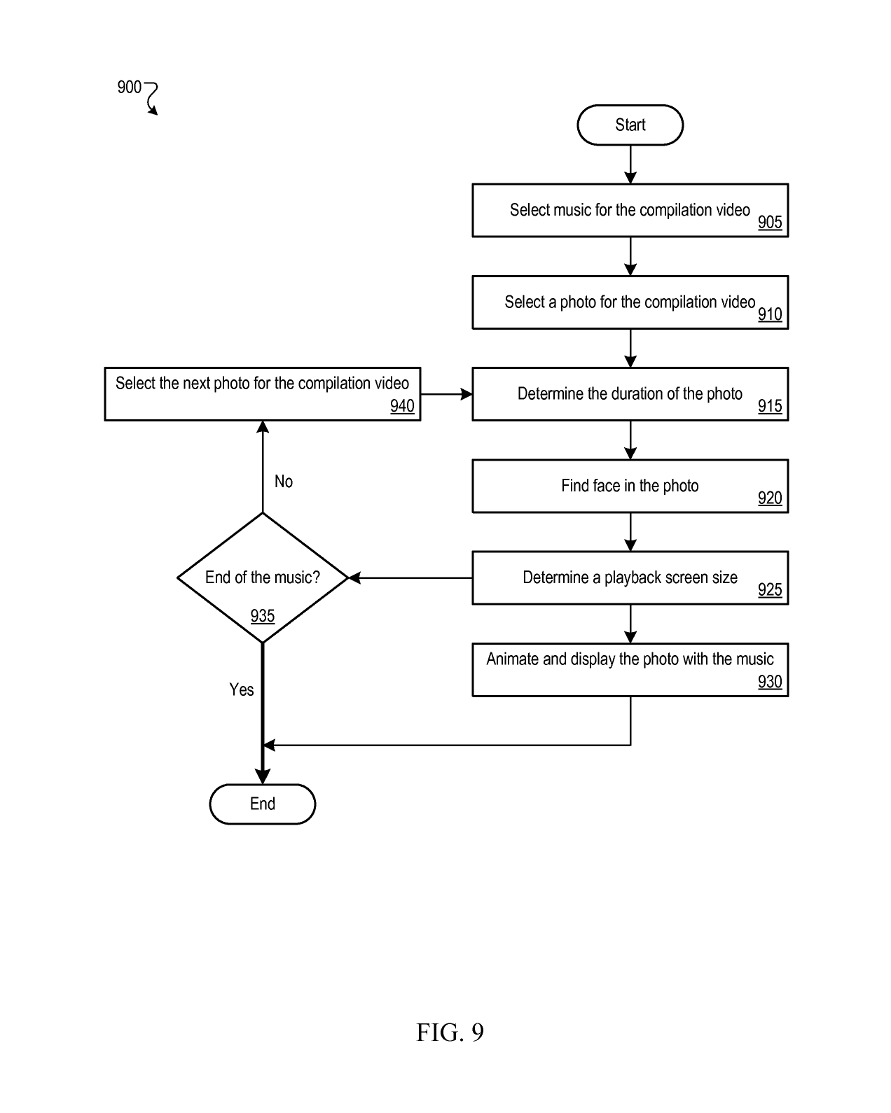

FIG. 9 illustrates an example flowchart of a process 900 for creating a compilation video from a source video using music according to some embodiments described. The process 900 may be executed by the controller 120 of FIG. 1 or by any other computing device. The process 900 may start at block 905.

At block 905, processing logic may select a music track for the compilation video. The music track may be selected, for example, in a manner similar to that described in block 805 of process 800 or block 510 of process 500. The music may be selected, for example, based on how interesting the music is as described above. The music track, for example, may be selected based on a relevance score of the music track.

At block 910, the processing logic may select a first photo for the compilation video. The first photo, for example, may be selected from a set of photos based on a relevance score of the photo.

At block 915, the processing logic may determine a duration for the first photo. The duration may affect the size or lengths of pans for Ken Burns effects. A shorter duration may speed up Ken Burns effects and a longer duration may allow for slower Ken Burns effects. The duration may be selected based on the number of photos from which the first photo was selected, the relevance score of the first photo, the length of the music track, or a number pulled from memory.

At block 920, the processing logic may find faces in the photo using facial detection techniques. A frame may be generated around any or all faces found in the photo. This frame may be used to keep the faces displayed during the compilation video.

At block 925, the processing logic may determine a playback screen size from the frame generated around the faces. The playback screen size may also be determined based on a function of the screen size of the device and/or the orientation of the device screen.

At block 930, the processing logic may animate the photo with Ken Burns effects and displayed it to the user with the music track. The Ken Burns effects may vary from photo to photo based on any number of factors such as, for example, random numbers, the relevance score of the photo, the playback screen size, the duration, a set number, etc. The photo may be animated and played with the music track.

Simultaneously while the photo is being animated and displayed, the processing logic may proceed to block 935 where the processing logic may determine whether the end of the music will be reached while the photo is being displayed. If yes, then the process 900 ends at the end of the music track at block 940. Alternatively and/or additionally, rather than ending at block 940, process 900 may return to block 905 where another music track is selected and process 900 repeats.

If, however, the end of the music track will not be reached while the photo is being displayed, then process 900 proceeds to block 940 where the next photo may be selected for the compilation video.

In some embodiments, photos may be sorted and/or ranked based on their relevance score. At block 940, for instance, the processing logic may select the next relevant photo. In some embodiments, the relevance score may be dynamically updated as information changes and/or as photos are added to the set of photos such as, for example, when a photo is downloaded from a remote server or transferred from a remote server, etc.

The processing logic may then proceed to block 915 with the next photo. Blocks 920, 925 and 930 may then act on the next photo as described above. In some embodiments, blocks 935, 940, 915, 920, and 925 may act on one photo while at block 930 another photo is being animated and displayed. In this way, for example, the compilation video may be animated and displayed in real time. Moreover, in some embodiments, blocks 915, 920 and 925 may occur simultaneously or in any order.

In some embodiments, the user may request that the music track selected in block 905 be replaced with another music track such as, for example, the next most relevant music track. The user, for example, may interact with the user interface 145 (e.g., by pressing a button or swiping a touch screen) and in response another music track will be selected and played at block 930. Moreover, In some embodiments, the user may request that a photo is no longer animated and displayed at block 930 such as, for example, by interacting with user interface 145 (e.g., by pressing a button or swiping a touch screen).

FIG. 10 illustrates an example flowchart of a process 1000 for creating a compilation video from a source video using supervised learning according to some embodiments. The process 1000 may be executed by the controller 120 of FIG. 1 or by any other computing device. The process 1000 may start at block 1005.

At block 1005, processing logic may collect raw data, which may include video data and interest data. The video data may come from a set of source videos from which a compilation video may be created. In some embodiments, the compilation video may be a summary of the set of source videos. The interest data may relate to interestingness of the video data to a particular user or group of users. The interest data may also relate to video quality, where low quality video may have a low interest. The processing logic may receive interest data pertaining to the set of source videos from a user. For example, the processing logic may present the videos to the user via an electronic display. While watching the set of source videos, the user may input interest data, such as via an external device (e.g., keyboard, mouse, or joystick). For example, the processing logic may present a binary (e.g., yes, no) interest option to the user. While the user watches the set of source videos, the user may select (e.g., using the mouse, keyboard or joystick) one of the two binary interest options. The processing logic may associate the selected binary option with the video frame that was playing at the time the processing logic received the selection of the binary interest option. In some embodiments, the processing logic may associate the selected binary option with multiple video frames without further input from a user. For example, the processing logic may identify characteristics of the video frame, identify other video frames with similar characteristics, and associate the selected binary option with the other video frames with the similar characteristics. For example, a video may include metadata that indicates an average magnitude of an acceleration on a device used to capture the video. The processing logic may identify video spikes in acceleration and may select video frames between spikes as a group. The processing logic may then receive a selection of a binary option for at least one of the video frames between two spikes. The processing logic may associate the selected binary option with the video frames between the two spikes. The interest data may relate to a single video frame or to a group of video frames. The processing logic stores the received interest data in a data storage. In some embodiments, the interest data may indicate a negative interest and may indicate that the video clips associated with the negative interest are not to be included in a compilation video and/or are to be removed from the set of source videos.

At block 1010, processing logic may identify metadata associated with some or all of the video data collected at block 1005, as further described in conjunction with block 510 of FIG. 5.

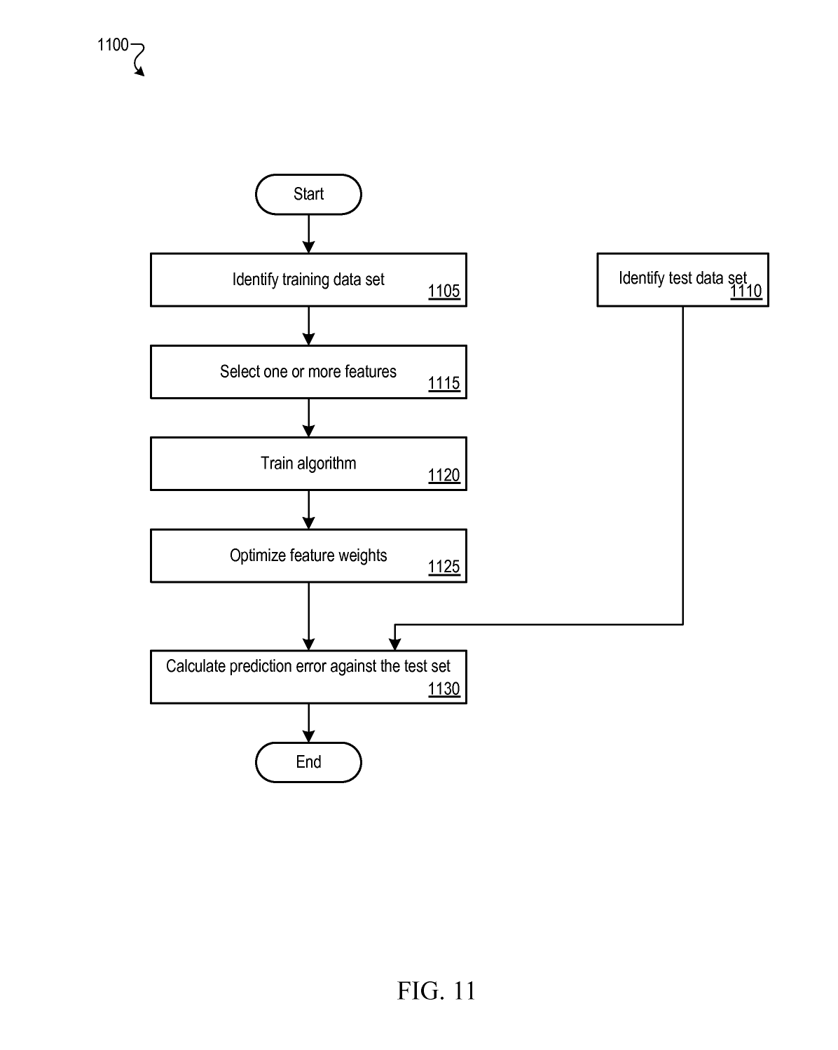

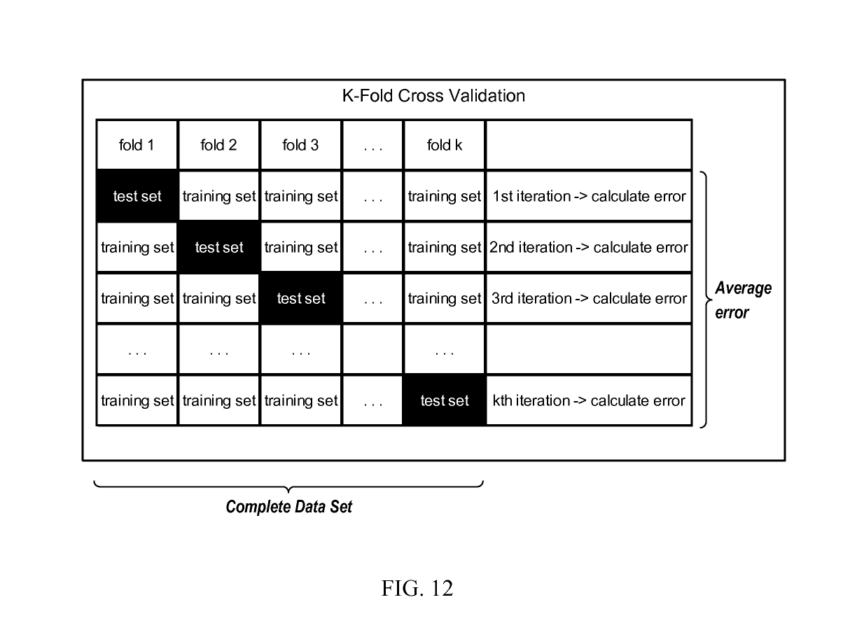

At block 1015, processing logic may create and validate a machine-learned algorithm, as further described in conjunction with FIG. 11. The processing logic may use the interest data and/or the metadata (e.g., features) to create the machine-learned algorithm. For example, the processing logic may identify certain metadata that are consistently identified by the user(s) as being interesting and/or high quality. The processing logic may use those identified metadata to create an algorithm that may be used to create a compilation video. The processing logic may test the algorithm, such as by using a first portion of the video data to create the algorithm and a second portion of the video data to test the algorithm. The processing logic may generate a first preliminary compilation video based on the first portion of the video data and may generate a second preliminary compilation video based on the second portion of the video data. The first preliminary compilation video and the second preliminary compilation video may be compared to validate the algorithm. When the first preliminary compilation video and the second preliminary compilation video are sufficiently similar, the processing logic can validate the algorithm. When the first preliminary compilation video and the second preliminary compilation video are not sufficiently similar, the processing logic can create another algorithm and validate a new compilation video. Further details relating to creating and validating a machine-learned algorithm are described in conjunction with FIG. 11. In some embodiments, the processing logic may use statistical analysis to validate the algorithm without generating a preliminary compilation video. For example, multi-fold validation (e.g., 4-fold validation) techniques may be used to validate the algorithm, as further described in conjunction with FIG. 12.

At block 1020, processing logic may select an algorithm that passes the validation at block 1015. In some embodiments, the processing logic may select from a set of algorithms based on the content of the video data. The processing logic may perform an initial scan of the video data for content and/or metadata to determine a topic of the video data. For example, the video data may include metadata (e.g., a geo-tag, a user generated tag) that identifies the video data as being associated with a rock concert at a particular time and venue. The processing logic may identify and select an algorithm for making compilations of rock concerts. In another example, by scanning the content of the video data, the processing logic may determine that the video is directed toward a wedding when the processing logic identifies a relatively large number of faces, people dressed in formal wear and some video clips that include a preacher. The processing logic may identify and select an algorithm for wedding videos after determining that the video data is directed to weddings. Any type of algorithm may be created and used for any type of video content. The processing logic may use some or all of blocks 1005, 1010, 1015 and 1020 to train a machine learning algorithm.

At block 1025, processing logic may perform a final classification of the selected algorithm to verify that the selected algorithm is likely to produce a highly-accurate compilation video. At block 1025, the processing logic may apply a trained algorithm (e.g., a machine learning algorithm trained at one or more of blocks 1005, 1010, 1015 and 1020) to an end user's video. In at least one embodiment, at block 1025, the processing logic may classify the user's video content as interesting/irrelevant based on the trained algorithm. For example, the processing logic may determine an interestingness score for one or more video frames or segments. Based on the length of the video, the processing logic may select one or more video frames or segments with an interestingness score above a threshold interestingness value for used in a compilation video, as created at block 1030.

At block 1030, processing logic may create a compilation video based on the selected algorithm, as described, for example, in conjunction with block 535 of FIG. 5 and block 615 of FIG. 6.

FIG. 11 illustrates an example flowchart of a process 1100 for creating and validating a machine-learned algorithm according to some embodiments. The process 1100 may be executed by the controller 120 of FIG. 1 or by any other computing device.

Process 1100 may be used to determine which of the different metadata (e.g., features) for a set of source videos may be interesting to a viewer as well as a degree of interestingness that each feature may represent. For example, the process may determine whether a larger amount of acceleration of the device that captured a video corresponds to interesting content or whether a smaller amount of acceleration corresponds to interesting content. Each feature may also be associated with a modifier to adjust a proportionality of interest of that feature relative to other features. In some embodiments, some features may be combined to be a new feature in the feature vector. For example, slow panning may be one feature in the feature vector and the combination of slow panning and a sharp tilt may be another feature in the feature vector. The process 1100 may start at block 1105.

At block 1105, processing logic may identify a training set of video data. The training set of video data may be a first portion of the video data received at block 1105 of FIG. 11 and may be used to create or train a machine-learning algorithm. At block 1110, the processing logic may identify a test set of video data. The test set of video data may be a second portion of the video data received at block 1105 of FIG. 11 and may be used to create or train a machine-learning algorithm.

At block 1115, the processing logic may select one or more features based on interest data, which may have been collected at block 1005 of FIG. 10. The processing logic may select features that are associated with video frames that were marked as “interesting” by one or more users. At block 1120, the processing logic may train an algorithm (e.g., create the baseline feature set) based on the selected features. To train the algorithm, the processing logic may iteratively analyze the video data to identify which types of video clips are most likely to be interesting for inclusion in a compilation video. For example, when multiple video clips of a famous monument are marked as being “interesting,” the processing logic may train the algorithm such that other, non-marked video clips of the famous monument may be marked as being interesting. In some embodiments, marking these features includes increasing a value in the baseline feature set that corresponds to the feature.

At block 1125, the processing logic may optimize feature weights for each feature based on a proportional interestingness of the feature. In some embodiments, the processing logic may modify values for various features in the baseline feature set based on those features proportional interestingness in relation to the other features. For example, the processing logic may identify that a slow pan is proportionally more interesting than fast acceleration so the processing logic can associate a proportional weight to the slow pan feature.

At block 1130, the processing logic may calculate a prediction error of the training set against the test set to determine how close the test set is to the training set. In some embodiments, the processing logic may generate a training feature vector for the training set and a test feature vector for the test set. The processing logic may compare the training feature vector with the test feature vector. In some embodiments, the processing logic may use statistical analysis techniques (e.g., regression) to determine whether the difference between the training feature vector with the test feature vector is within an acceptable margin of error. When the training feature vector is within the acceptable margin of error from the test feature vector, the processing logic may determine that the training feature vector and the test feature vector are similar enough to use the algorithm (e.g., baseline feature set) determined at block 1120 to create a compilation video. In some embodiments, when the training feature vector and the test feature vector are not within an acceptable margin of error, the processing logic may analyze which features may have different values in each respective feature vector. Using the test set as the baseline, the processing logic may apply a multiplier/divisor to any feature in the training feature vector to make the resulting training vector closer to the test feature vector.

FIG. 12 illustrates an example cross validation model to train an algorithm for creating compilation videos in accordance with some embodiments. Cross validation is an example model validation technique that may be used to assess how accurately a predictive model may perform in practice. In k-fold cross-validation, the original data may be randomly partitioned into k equal sized subsamples. Of the k subsamples, a single subsample may be retained as the validation data for testing the model, and the remaining k−1 subsamples may be used as training data. The cross-validation process may be then repeated k times (i.e., the folds), with each of the k subsamples used once as the validation data. The k results from the folds may then be averaged or otherwise combined to produce a single estimation. The advantage of this method over repeated random sub-sampling (see below) may be that all observations are used for both training and validation, and each observation may be used for validation once. The parameter, k, may be any positive whole number and is typically 4 or more.

As illustrated, the example k-fold cross validation model has 4 folds, but any number of folds may be used. When using 4 folds, 75% of the video data may be used for training and then 25% of the video data may be for testing. The testing may repeat four times with different subsets of video data. Errors may be calculated as part of each iteration and an average error may be calculated from the various calculated errors. This testing may result in a model that extracts which features in the feature vector (e.g., which of the 68 features) are the most interesting. The k-fold mode, for example, can indicate the top ten or top 25 features. These “most interesting” features may be used to generate subsequent compilation videos.

A computer system 1300 (or processing unit) illustrated in FIG. 13 may be used to perform any of the embodiments of the invention. The computer system 1300 executes one or more sets of instructions 1326 that cause the machine to perform any one or more of the methodologies discussed herein. The machine may operate in the capacity of a server or a client machine in client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions 1326 to perform any one or more of the methodologies discussed herein.

The computer system 1300 includes a processor 1302, a main memory 1304 (e.g., read-only memory (ROM), flash memory, dynamic random access memory (DRAM) such as synchronous DRAM (SDRAM) or Rambus DRAM (RDRAM), etc.), a static memory 1306 (e.g., flash memory, static random access memory (SRAM), etc.), and a data storage device 1316, which communicate with each other via a bus 1308.

The processor 1302 represents one or more general-purpose processing devices such as a microprocessor, central processing unit, or the like. More particularly, the processor 1302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1302 may also be one or more special-purpose processing devices such as an application specific integrated circuit (ASIC), a field programmable gate array (FPGA), a digital signal processor (DSP), network processor, or the like. The processor 1302 is configured to execute instructions for performing the operations and steps discussed herein.

The computer system 1300 may further include a network interface device 1322 that provides communication with other machines over a network 1318, such as a local area network (LAN), an intranet, an extranet, or the Internet. The network interface device 1322 may include any number of physical or logical interfaces. The network interface device 1322 may include any device, system, component, or collection of components configured to allow or facilitate communication between network components in an ICN network. For example, the network interface device 1322 may include, without limitation, a modem, a network card (wireless or wired), an infrared communication device, an optical communication device, a wireless communication device (such as an antenna), and/or chipset (such as a Bluetooth device, an 802.6 device (e.g. Metropolitan Area Network (MAN)), a WiFi device, a WiMax device, cellular communication facilities, etc.), and/or the like. The network interface device 1322 may permit data to be exchanged with a network (such as a cellular network, a WiFi network, a MAN, an optical network, etc., to name a few examples) and/or any other devices described in the present disclosure, including remote devices. In some embodiments, the network interface device 1322 may be logical distinctions on a single physical component, for example, multiple communication streams across a single physical cable or optical signal.

The computer system 1300 also may include a display device 1310 (e.g., a liquid crystal display (LCD) or a cathode ray tube (CRT)), an alphanumeric input device 1312 (e.g., a keyboard), a cursor control device 1314 (e.g., a mouse), and a signal generation device 1320 (e.g., a speaker).

The data storage device 1316 may include a computer-readable storage medium 1324 on which is stored the sets of instructions 1326 embodying any one or more of the methodologies or functions described herein. The sets of instructions 1326 may also reside, completely or at least partially, within the main memory 1304 and/or within the processor 1302 during execution thereof by the computer system 1300, the main memory 1304 and the processor 1302 also constituting computer-readable storage media. The sets of instructions 1326 may further be transmitted or received over the network 1318 via the network interface device 1322.

While the example of the computer-readable storage medium 1324 is shown as a single medium, the term “computer-readable storage medium” can include a single medium or multiple media (e.g., a centralized or distributed database, and/or associated caches and servers) that store the sets of instructions 1326. The term “computer-readable storage medium” can include any medium that is capable of storing, encoding or carrying a set of instructions for execution by the machine and that cause the machine to perform any one or more of the methodologies of the present disclosure. The term “computer-readable storage medium” can include, but not be limited to, solid-state memories, optical media, and magnetic media.

Modifications, additions, or omissions may be made to the computer system 1300 without departing from the scope of the present disclosure. For example, in some embodiments, the computer system 1300 may include any number of other components that may not be explicitly illustrated or described.

Numerous specific details are set forth to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed are not limited to any particular hardware architecture or configuration. A computing device may include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained in software to be used in programming or configuring a computing device.

Embodiments of the methods disclosed may be performed in the operation of such computing devices. The order of the blocks presented in the examples above may be varied—for example, blocks may be re-ordered, combined, and/or broken into sub-blocks. Certain blocks or processes may be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method for creating a compilation video, the method comprising:
receiving a source video having a set of video frames, each video frame in the set of video frames having associated metadata;
generating a relevance score for each video frame in the set of video frames based on the associated metadata;
selecting a first video frame from the set of video frames based on a first relevance score for the first video frame; and
creating the compilation video that includes the first video frame.

2. The method of claim 1, further comprising:
identifying a second set of video frames;
generating a relevance score for each video frame in the second set of video frames; and
selecting a second video frame from the second set of video frames based on a second relevance score for the second video frame, and wherein the compilation video is created to include the second video frame.

3. The method of claim 1, wherein the associated metadata comprises at least one of: geolocation data, motion data, people tag data, voice tag data, motion tag data, time data, or audio data.

4. The method of claim 1, further comprising receiving a digital audio file that includes a song, wherein the compilation video is created to have a length that is a same length as the length of the song.

5. The method of claim 1, wherein the compilation video has a shorter length than the source video.

6. The method of claim 1, wherein the relevance score is a binary value indicative of a location, an orientation, a track volume threshold parameter, a voice tag parameter, a motion, or a person.

7. The method of claim 1, further comprising:
storing the relevance score for each video frame in a machine-learning database in an aggregate record of relevance scores for each video frame; and
creating a second compilation video based on the aggregate record.

8. An non-transitory computer readable storage medium having encoded therein programming code executable by a processor to perform operations comprising:
receiving a source video having a set of video frames, each video frame in the set of video frames having associated metadata;
generating a relevance score for each video frame in the set of video frames based on the associated metadata;
selecting a first video frame from the set of video frames based on a first relevance score for the first video frame; and
creating the compilation video that includes the first video frame.

9. The non-transitory computer readable storage medium of claim 8, the operations further comprising:
identifying a second set of video frames;
generating a relevance score for each video frame in the second set of video frames; and
selecting a second video frame from the second set of video frames based on a second relevance score for the second video frame, and wherein the compilation video is created to include the second video frame.

10. The non-transitory computer readable storage medium of claim 8, wherein the associated metadata comprises at least one of: geolocation data, motion data, people tag data, voice tag data, motion tag data, time data, or audio data.

11. The non-transitory computer readable storage medium of claim 8, the operations further comprising receiving a digital audio file that includes a song, wherein the compilation video is created to have a length that is a same length as the length of the song.

12. The non-transitory computer readable storage medium of claim 8, wherein the relevance score is a binary value indicative of a location, an orientation, a track volume threshold parameter, a voice tag parameter, a motion, or a person.

13. The non-transitory computer readable storage medium of claim 8, the operations further comprising:
storing the relevance score for each video frame in a machine-learning database in an aggregate record of relevance scores for each video frame; and
creating a second compilation video based on the aggregate record.

14. A mobile device comprising:
an image sensor;
a memory; and
a processor operatively coupled to the memory, wherein the processor is configured to:
receive a source video having a set of video frames, each video frame in the set of video frames having associated metadata;
generate a relevance score for each video frame in the set of video frames based on the associated metadata;
select a first video frame from the set of video frames based on a first relevance score for the first video frame; and
create a compilation video that includes the first video frame.

15. The mobile device of claim 14, wherein the processor is further configured to:
identify a second set of video frames;
generate a relevance score for each video frame in the second set of video frames; and
select a second video frame from the second set of video frames based on a second relevance score for the second video frame, and wherein the compilation video is created to include the second video frame.

16. The mobile device of claim 14, wherein the associated metadata comprises at least one of: geolocation data, motion data, people tag data, voice tag data, motion tag data, time data, or audio data.

17. The mobile device of claim 14, wherein the processor is further configured to receive a digital audio file that includes a song, wherein the compilation video is created to have a length that is a same length as the length of the song.

18. The mobile device of claim 14, wherein the compilation video has a shorter length than the source video.

19. The mobile device of claim 14, wherein the relevance score is a binary value indicative of a location, an orientation, a track volume threshold parameter, a voice tag parameter, a motion, or a person.

20. The mobile device of claim 14, wherein the processor is further configured to:
store the relevance score for each video frame in a machine-learning database in an aggregate record of relevance scores for each video frame; and
create a second compilation video based on the aggregate record.
